(19) United States
(12) Patent Application Publication
(10) Pub. No.: US 2014/0372111 A1
(43) Pub. Date: Dec. 18, 2014

(54) VOICE RECOGNITION ENHANCEMENT

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/182,193

(22) Filed: Feb. 17, 2014

Related U.S. Application Data
(60) Provisional application No. 61/765,620, filed on Feb. 15, 2013.

(51) Int. Cl. G10L 21/0364; H04M 1/60

(52) U.S. Cl. CPC G10L 21/0364; H04M 1/60
USPC 704/227

(57) ABSTRACT

A Voice Recognition Enhancement Method for wireless telephonic communication devices includes providing an input voice audio source, enhancing the voice audio input in one or more of harmonic and dynamic ranges and outputting the voice enhanced audio. The Voice Recognition Enhancement method is suitable for use of wireless telephony devices, such as cellular phones. The enhancement includes resynthesizing audio to an increased harmonic and dynamic range than original values.

### CROSS-REFERENCE TO RELATED PATENT APPLICATIONS

Embodiments of the present invention relate to U.S. (Provisional/CIP . . . ) Application Ser. No. 61/765,620, filed Feb. 15, 2013, entitled “VOICE RECOGNITION ENHANCEMENT”, the contents of which are incorporated by reference herein and which is a basis for a claim of priority.

### BACKGROUND OF THE INVENTION

Human voice has a frequency range that extends from 80 Hz to 14 kHz. However, traditional, voice band or narrowband telephone calls limit audio frequencies to the range of 300 Hz to 3.4 kHz. As a result, when humans communicate over telephone lines, there is resulting loss of quality in the voice heard through phone lines due to the loss in the frequency range.

Wideband audio, also known as HD voice, refers to the “next generation” of voice quality for telephony audio resulting in high definition voice quality compared to standard digital telephony “toll quality”.

HD voice extends the frequency range of audio signals transmitted over telephone lines, resulting in an expanded frequency range and therefore higher quality speech. Typical wideband audio systems relax the bandwidth limitation and transmits in the audio frequency range of 50 Hz to 7 kHz or higher.

Accordingly, communication devices, such as cellular phones, which rely on limited narrow band widths, have transmission that is very limited in its audio range. Due to this limitation in the available frequency range, manufacturers of telephonic communication devices will only make devices that operate within this criteria. As an example, cell phone manufacturers would not manufacture a full 20 to 20 kHz audio capable phone, as it would not cost efficient since the improvement could not be above what the transmission is capable of. At this time, wideband is not yet a commonly used format.

Due to the limited range of available bandwidth, telecommunication devices that rely on such bandwidth, such as cell phones, utilize electronics and circuitry that have a very narrow frequency range. This limited range results in anything from degraded to garbled voice quality on the receiving user.

To address the resulting problem of degraded and low quality voice, conventional voice recognition engines in telecommunication devices heavily rely on digital signal processing (DSP) to compensate for the limitations in the band width of the voice signals.

Therefore conventional improvements to voice quality are based on increased reliance on digital signal processing techniques.

There is a need for an application that addresses the above deficiencies of existing systems that can add detail and intelligibility to received audio without the need for additional hardware.

### SUMMARY OF THE INVENTION

Voice intelligibility is, among other factors, dependent upon consonant recognition. Most consonants have percussive leading edges. So, for example, by enhancing these consonants, the process makes speech more intelligible. Moreover, the level of such increase would be small which will prevent an increase in reverberation, as, for example, would be the case with simple equalization. The effect helps intelligibility in a noisy environment as well by supplying more cues. The benefits are realizable from full response systems to low fidelity telephones. Tuning, of course, would be different for different applications.

The inventive Voice Recognition Enhancement includes a harmonics generator that ‘looks’ for transients in the input voice signal and generates more harmonics on those transients, essentially enhancing the transients while leaving the non-transient material untouched.

As a result, the VRE improves the “source” that feeds the specific telephony product thereby allowing the product to perform as the manufacture intended and is not limited due to compressed sound files.

Applying the inventive VRE method and system to voice audio results in an audio that is much clearer and easier to discern the voice user is listening to. This process is a digital process meant to be used in the DSP of a device. It can be used on both inbound and outbound calls for improvement of both. On the outbound call, the device receiving the call will receive better than “normal” audio quality because of the process.

As the process increase the intelligibility of the audio, it provides the existing voice recognition engine with processed audio of much greater intelligibility than without. Thus allowing the existing engine to function with a higher degree of accuracy at a lower DSP cost than totally replacing it.

### BRIEF DESCRIPTION OF THE DRAWINGS

FIG. 1 is a block diagram of an exemplary embodiment of the Voice Recognition Enhancement method of the present invention corresponding to an inbound telephone call.

FIG. 2 is a block diagram of an exemplary embodiment of the Voice Recognition Enhancement method of the present invention corresponding to an outbound telephone call.

FIG. 3(A) is a depiction of signals corresponding to a typical voice call from a cell phone.

FIG. 3(B) is a depiction of signals corresponding to a typical voice call from a cell phone that has been processed by the Voice Recognition Enhancement method of the present invention.

### DETAILED DESCRIPTION OF THE PREFERRED EMBODIMENT(S)

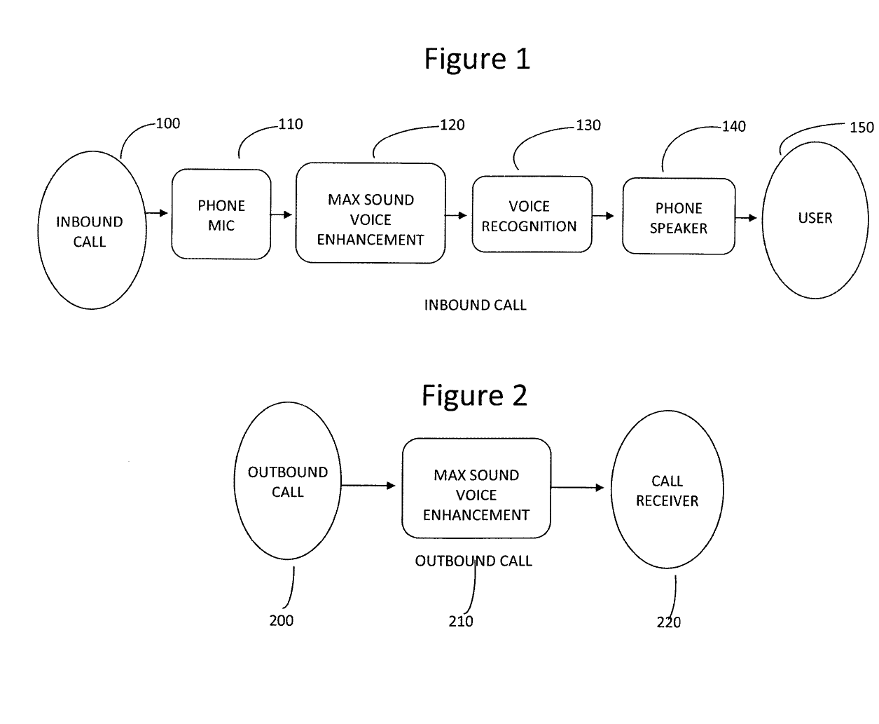

An embodiment of the operation of the Voice Recognition Enhancement Method and system of the present invention is depicted in the block diagram of FIG. 1. Preferably, the inventive VRE process is performed by a single processor module identified by reference numeral 120 in the system shown in the block diagram of FIG. 1 corresponding to an incoming call, and reference numeral 210 in the outbound set up shown in FIG. 2.

As shown in FIG. 1, inbound call 100 is received by a telephony through a microphone 110. Signal from the microphone 110 is fed to the inventive VRE processor, where the sound signal is processed for enhancement. Voice enhancement at this step is accomplished by restoring (resynthesizing) the inbound voice audio to a much greater harmonic and dynamic range than that possessed by the original voice signal. For example, an incoming voice signal with a 16 bit audio range can be expanded into a 20 bit range. Advantageously, utilizing this process requires no change in the hardware of the receiving device.

According to the VRE process of the present invention, the harmonic and dynamic properties of the voice signal are resynthesized into a full range PCM (Pulse-code modulation) wave with extended audio content. More harmonic and dynamic information is generated resulting in extended (increased) audio content. This, in turn, provides much more clarity to the compressed, band limited audio available in the existing cell audio.

FIG. 2 shows a corresponding exemplary application of the inventive VRE process for an outbound call. As provided in this example, user speaks into the device's microphone for an outbound call 200. Sound waves corresponding to the voice of the caller are subsequently fed to and are processed by the inventive VRE module 210, where they are enhanced as described above prior to being sent out of the device to a call receiver 220. The resulting VRE processed sound is much clearer, more real sounding wave that is transmitted to the call receiver. The transmitted wave retains much of the quality of the original voice, even though it has to be compressed by the cell phone system.

Advantageously, the Voice Enhancement Process of the present invention can be used with any conventional voice recognition system, including those not associated with making phone calls. These include for example voice dictation and use of programs that respond to voice (such as SIRI).

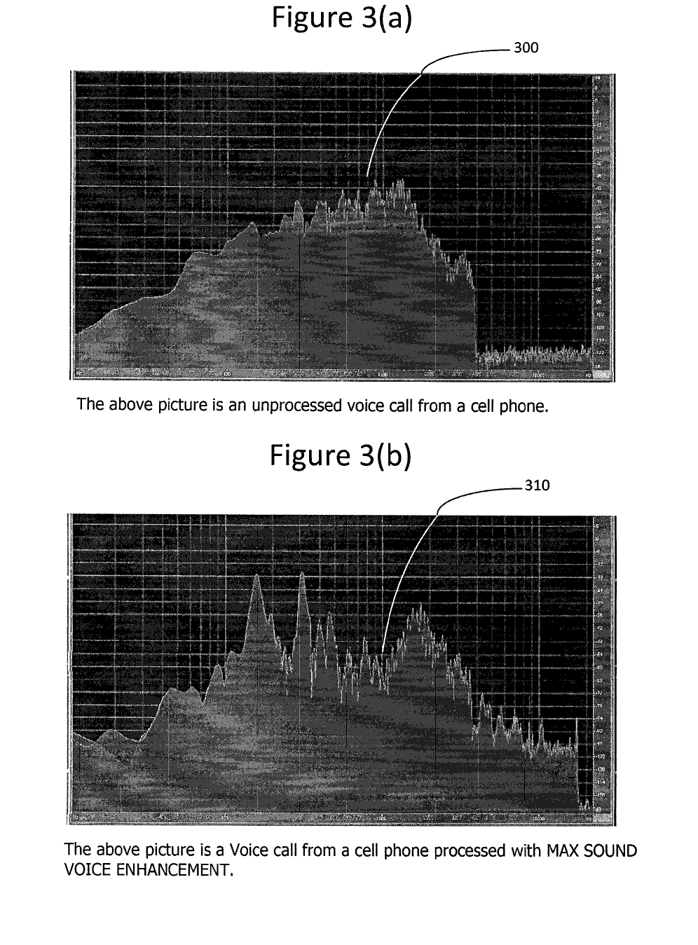

FIGS. 3(a) and 3(b) correspond to images of a sound waves 300 and 310, corresponding to a voice call from a cellular phone prior to and following processing by the inventive VRE process.

Reference numeral 300 corresponds to the pre-processed sound, while reference numeral 310 corresponds to the sound 300 that has been processed by the inventive. From the two graphic examples of a voice call without and with the Voice Call Enhancement it is clear that material has been resynthesized into the processed wave, thus making it much clearer and much more discernible to the listener. In the provided examples, from left to right represents frequency range 0 Hz to 20 kHz and amplitude range of −140 to 0 DBFS. The FFT size is 8192 and the FFT type is Blackman-Harris.

What is claimed is:

1. A Voice Recognition Enhancement Method for wireless telephonic communication devices comprising:
Providing an input voice audio source;
Enhancing the voice audio input in one or more of harmonic and dynamic ranges;
Outputting the voice enhanced audio.

2. The Voice Recognition Enhancement Method of claim 1 wherein the wireless communication device is a cellular phone.

3. The Voice Recognition Enhancement Method of claim 1 wherein the enhancement includes resynthesizing audio to an increased harmonic and dynamic range than original values.

4. The Voice Recognition Enhancement Method of claim 1, wherein the enhancement includes enhancing sound consonants.
